(19) United States
(12) Patent Application Publication
(10) Pub. No.: US 2026/0098707 A1
(43) Pub. Date: Apr. 9, 2026

(54) HOLOGRAPHIC SIGHT

(71) Applicant: Addtac Inc, Irvine, CA (US)

(72) Inventor: Lee Niu, Chino Hills, CA (US)

(73) Assignee: Addtac Inc, Irvine, CA (US)

(21) Appl. No.: 19/040,807

(22) Filed: Jan. 29, 2025

Related U.S. Application Data
(60) Provisional application No. 63/703,163, filed on Oct. 3, 2024.
(60) Provisional application No. 63/747,351, filed on Jan. 21, 2025.

(51) Int. Cl. F41G 1/30; F41G 11/00; G02B 5/32

(52) U.S. Cl. CPC F41G 1/30; F41G 11/00; G02B 5/32

(57) ABSTRACT

A holographic sight includes a light source configured to generate a light beam, and a holographic plate configured to convert light to a holographic reticle. The holographic sight further includes a target side window and a viewing window having a smaller dimension than the target side window, and a housing defining apertures for receiving the target side window and the viewing window and configured to house the light source and the holographic plate.

### PRIORITY CLAIM

This application claims the benefit and priority of U.S. Provisional Application No. 63/703,163, titled HOLOGRAPHIC SIGHT and filed on Oct. 3, 2024, the entire disclosure of which is expressly incorporated by reference herein in its entirety; this application also claims the benefit and priority of U.S. Provisional Application No. 63/747,351, titled HOLOGRAPHIC SIGHT and filed on Jan. 20, 2025, the entire disclosure of which is expressly incorporated by reference herein in its entirety

### BACKGROUND

### Field

The present disclosure is directed to holographic sights and, more particularly, to holographic sights for use with weapons.

### Description of the Related Art

Sights for weapons, such as sights that are installed on a receiver of a firearm, are designed to assist a user in aiming the weapon. These sights can take any form such as iron sights that include a metal form on the receiver, laser sights that aim a laser towards a target, reflex sights that project a dot onto a reflexive glass, or the like. Each type of sight has benefits and drawbacks. Recently, efforts have been made towards developing a new type of sight: holographic sights. Conventional holographic sights also have significant drawbacks and are relatively expensive, thus deterring widespread adoption.

Thus, there is a need in the art for systems and methods for improved holographic sights.

### SUMMARY

Described herein is a holographic sight. The holographic sight includes a light source configured to generate a light beam, and a holographic plate configured to convert light to a holographic reticle. The holographic sight further includes a target side window and a viewing window having a smaller dimension than the target side window, and a housing defining apertures for receiving the target side window and the viewing window and configured to house the light source and the holographic plate.

In any of the foregoing embodiments, the housing is configured to be mounted on a receiver of a firearm, the receiver having a longitudinal axis.

In any of the foregoing embodiments, the housing has a height extending perpendicular to the longitudinal axis of the receiver and a length extending parallel to the longitudinal axis of the receiver; and the height of the housing is greater than the length of the housing.

In any of the foregoing embodiments, the height of the housing is greater than 1.3 times the length of the housing.

In any of the foregoing embodiments, the housing includes internal walls defining a viewing channel between the aperture for the target side window and the aperture for the viewing window, wherein a portion of at least one of the internal walls is tapered from the aperture for the target side window to the aperture for the viewing window.

In any of the foregoing embodiments, the internal walls include horizontal walls and vertical walls; the horizontal walls include a bottom wall and a top wall configured to be positioned farther from the receiver than the bottom wall; and at least one of the bottom wall or the top wall is tapered towards the other of the bottom wall or the top wall from the aperture for the target side window to the aperture for the viewing window.

In any of the foregoing embodiments, the vertical walls include a first vertical wall and a second vertical wall; and at least one of the first vertical wall or the second vertical wall is tapered towards the other of the first vertical wall or the second vertical wall from the aperture for the target side window to the aperture for the viewing window.

In any of the foregoing embodiments, the holographic plate is positioned within the viewing channel and oriented in a direction parallel to the aperture for the target side window and the aperture for the viewing window.

In any of the foregoing embodiments, the housing includes a first outer side wall and a second outer side wall oriented substantially parallel to the first outer side wall, and wherein the first outer side wall and the second outer side wall are oriented substantially perpendicular to the longitudinal axis of the receiver.

Any of the foregoing embodiments may further include at least two buttons each positioned on one of the first outer side wall or the second outer side wall and positioned adjacent to the remaining at least two buttons.

Any of the foregoing embodiments may further include a circuit board configured to be housed within the housing and oriented parallel to at least one of the first outer side wall or the second outer side wall.

In any of the foregoing embodiments, the housing further defines a battery box configured to receive a battery, and wherein the battery box is positioned between the receiver and the apertures for the viewing window and the target side window, and positioned closer to the viewing window than the target side window.

Also described is a holographic sight for use with a firearm. The holographic sight includes a light source configured to generate a light beam, and a holographic plate configured to convert light to a holographic reticle. The holographic sight further includes a target side window and a viewing window. The holographic sight also includes a housing defining apertures for receiving the target side window and the viewing window, configured to house the light source and the holographic plate, and configured to be coupled to a receiver of the firearm, the housing having a length extending parallel to the longitudinal axis of the receiver and a height extending perpendicular to a longitudinal axis of the receiver and being greater than the length.

In any of the foregoing embodiments, the target side window has a different dimension than the viewing side window.

In any of the foregoing embodiments, the housing includes internal walls defining a viewing channel between the aperture for the target side window and the aperture for the viewing window, wherein a portion of at least one of the internal walls is tapered from the aperture for the target side window to the aperture for the viewing window.

In any of the foregoing embodiments, the holographic plate is positioned within the viewing channel and oriented in a direction parallel to the aperture for the target side window and the aperture for the viewing window.

In any of the foregoing embodiments, the height of the housing is greater than 1.3 times the length of the housing.

Also described is a sight for use with a firearm. The sight includes a target side aperture and a viewing aperture having a smaller dimension than the target side aperture. The sight further includes internal walls defining a viewing channel between the target side aperture and the viewing aperture. The sight further includes a reticle-forming element observable by peering through the viewing channel via the viewing aperture. The sight further includes a housing at least partially defining or coupled to the target side aperture, the viewing aperture, the internal walls, and the reticle-forming element, and configured to be coupled to a receiver of the firearm. At least a portion of at least one of the internal walls is tapered from the target side aperture to the viewing aperture.

In any of the foregoing embodiments, the internal walls include horizontal walls and vertical walls, the horizontal walls include a bottom wall and a top wall configured to be positioned farther from the receiver than the bottom wall, and at least one of the bottom wall or the top wall is tapered towards the other of the bottom wall or the top wall between the target side aperture and the viewing aperture such that the target side aperture has at least one dimension that is greater than a corresponding dimension of the viewing aperture.

In any of the foregoing embodiments, the vertical walls include a first vertical wall and a second vertical wall, and at least one of the first vertical wall or the second vertical wall is tapered towards the other of the first vertical wall or the second vertical wall from the target side aperture to the viewing aperture such that the target side aperture has at least two dimensions that are greater than corresponding dimensions of the viewing aperture.

### BRIEF DESCRIPTION OF THE DRAWINGS

Other systems, methods, features, and advantages of the present disclosure will be or will become apparent to one of ordinary skill in the art upon examination of the following figures and detailed description. It is intended that all such additional systems, methods, features, and advantages be included within this description, be within the scope of the present disclosure, and be protected by the accompanying claims. Component parts shown in the drawings are not necessarily to scale, and may be exaggerated to better illustrate the important features of the present disclosure. In the drawings, like reference numerals designate like parts throughout the different views, wherein:

FIG. 1A is a front perspective view of a holographic sight, according to various embodiments of the present disclosure;

FIG. 1B is another front perspective view of a holographic sight, according to various embodiments of the present disclosure;

FIG. 1C is a first side view of a holographic sight, according to various embodiments of the present disclosure;

FIG. 1D is a second side view of a holographic sight, according to various embodiments of the present disclosure;

FIG. 2A is a front view, or target side view, of a holographic sight, according to various embodiments of the present disclosure;

FIG. 2B is a rear view, or user side view, of a holographic sight, according to various embodiments of the present disclosure;

FIG. 2C is a bottom view of a holographic sight, according to various embodiments of the present disclosure;

FIG. 2D is a top view of a holographic sight, according to various embodiments of the present disclosure;

FIG. 3 is a cross-sectional side view of a holographic sight illustrating optical components, according to various embodiments of the present disclosure;

FIG. 4 is an exploded view of various components of a holographic sight, according to various embodiments of the present disclosure;

FIG. 5 is a top-down cross-sectional view of a holographic sight illustrating a horizontal viewing angle, according to various embodiments of the present disclosure;

FIG. 6 is a cross-sectional side view of a holographic sight illustrating a vertical viewing angle, according to various embodiments of the present disclosure;

FIG. 7 is a side perspective view of a light source and adjustment mechanism for use with a holographic sight, according to various embodiments of the present disclosure; and

FIG. 8 is a front perspective view of a light source and adjustment mechanism for use with a holographic sight, according to various embodiments of the present disclosure.

### DETAILED DESCRIPTION

The present disclosure is directed to holographic sights. The holographic sights may be used with weapons; for example, the holographic sights may be mounted on a receiver of a firearm or on a frame of a crossbow. However, the holographic sights may also be used with non-weapons in some situations. A holographic sight is a sight for use with weapons that allows a user to look through a transparent or translucent window to see a holographic reticle image superimposed at a distance on the field of view through the window. Holographic sights may be non-magnifying or magnifying. In an exemplary implementation, a laser transmission hologram of the reticle image is recorded onto holographic film such that the reticle image is part of the optical viewing window, superimposing the reticle on the view through the holographic sight.

The holographic sights disclosed herein provide several benefits and advantages over conventional holographic sights. Because the holographic sights disclosed herein utilize a unique light path, a length of the holographic sight may be reduced and a height of the holographic sight may be increased, both relative to conventional holographic sights, which provides multiple benefits. One such benefit is that the holographic sights of the present disclosure have a shorter length than conventional holographic sights (i.e., extend by a reduced distance along the axis of a firearm receiver), advantageously allowing more components to be installed or mounted on the firearm receiver. The shortened length of the holographic sights herein provides additional advantages such as allowing the holographic sight to be installed on a handgun (as opposed to conventional holographic sights that can only be installed on a rifle). Because the height of the holographic sights disclosed herein are greater than a height of conventional holographic sights (i.e., extend by an increased distance in a direction perpendicular to, and away from, the axis of the firearm receiver), the viewing window of the holographic sights may be better aligned with a user's eye while in a natural shooting position (as opposed to conventional holographic sights which are often installed on top of an additional riser to elevate the viewing window farther away from the firearm receiver).

The holographic sights disclosed herein advantageously include a front window that is larger than a rear window. These dimension result in an inner wall being tapered between the front and rear windows, thus reducing the likelihood of any obstructions caused by the inner wall of the sight. The holographic sights disclosed herein are designed to receive a battery in a battery socket that is located underneath a viewing window (e.g., the front window), beneficially reducing a total volume of the holographic sight relative to conventional holographic sights. The sights disclosed herein advantageously place buttons for receiving input together on a side of the sight, further reducing a total volume of the holographic sights and reducing complexity and cost of waterproofing the sight. An internal circuit board of the sights is installed on an inner wall of the sights, further reducing a total volume required to house the sights.

An exemplary holographic sight has a housing along with a front, or target side, window and a rear, or viewing, window opposite the front window. A user may peer through the sight by looking into the viewing window and out of the target side window. The sight further includes a light source (e.g., a laser diode or light emitting diode (LED)) which emits light towards one or more mirrors, which direct the light towards a grating plate. Grated (i.e., diffracted) light from the grating plate travels to a holographic plate, which then forms a reticle viewable through the rear window. The front window has greater dimensions than the rear window to reduce the likelihood that the view through the holographic sight is obstructed by internal walls. The sight further includes inputs, such as adjustment wheels, that allow for horizontal and vertical adjustment of the sight to better align the reticle with a target. The sight also includes a circuit board installed inside the housing, and input devices (e.g., buttons) installed in or on the housing. The input devices may be coupled to the circuit board and used to adjust various parameters of the holographic sight (such as an intensity of the light, nigh vision on and off, or the like).

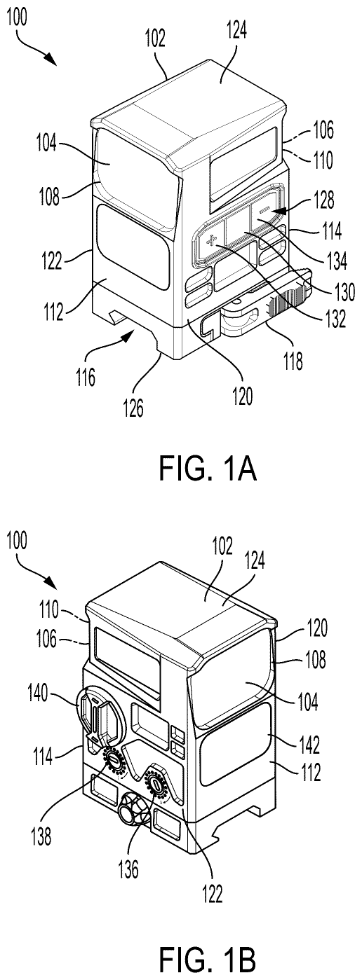

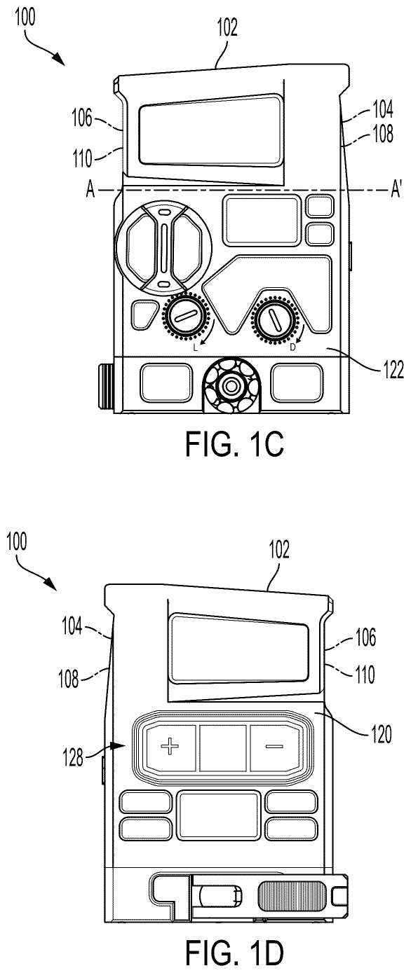

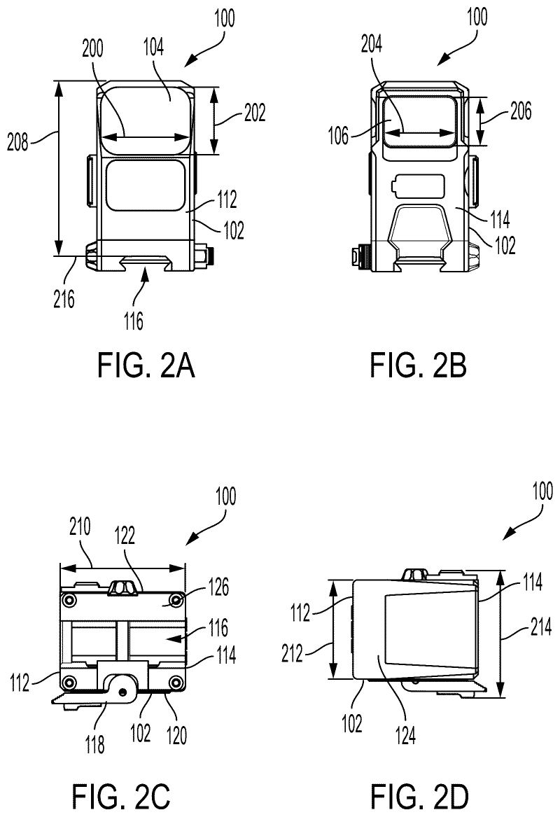

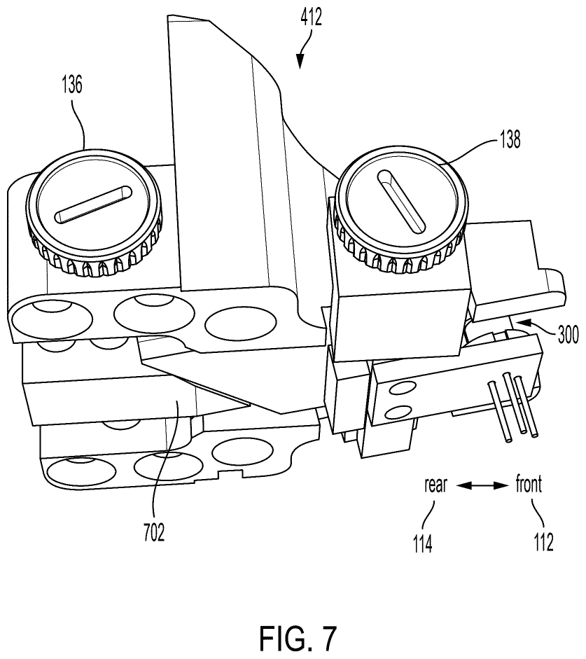

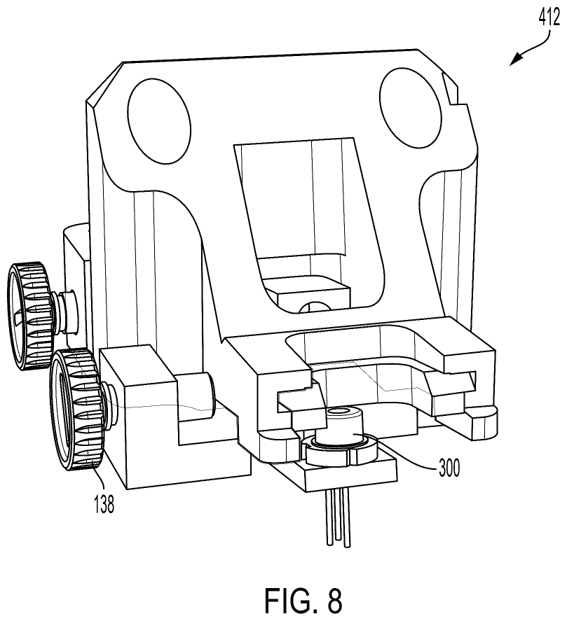

Referring generally to FIGS. 1A through 8, an exemplary holographic sight 100 (or sight 100) is shown. The sight 100 may be used with a weapon such as a firearm. The holographic sight 100 includes features that provide significant advantages over conventional weapons sights, as discussed above. As discussed in more detail below, the sight 100 may include a holographic plate inserted in a light path that positions a holographic reticle (or “reticle”) in a viewing window, allowing a user to aim a weapon based on the location of the reticle in the viewing window.

The holographic sight 100 may include a housing 102, a target side window 104, and a viewing window 106. The housing 102 may define a target side aperture 108 in which the target side window 104 is placed and a viewing aperture 110 in which the viewing window 106 is placed. The windows 104, 106 are designed for a user to look into the viewing window 106 and out of the target side window 104; i.e., the viewing window 106 faces an eye of the user and the target side window 104 faces a target. The housing 102 may be formed using any solid materials such as a metal, plastics, a polymer, or any combination of materials (e.g., a frame 401 formed using metal and a polymer coupled to the frame 401). The windows 104, 106 may be formed using any clear materials such as glass (e.g., borosilicate glass or soda lime glass), a plastic (e.g., acrylic), a polymer (e.g., polyethylene terephthalate (PET)), or any other clear materials. Additional components of the sight 100 may be formed using any known materials without departing from the scope of the present disclosure. In some embodiments, the components of the sight 100 may be sealed together such that the housing 102 is resistant to intrusion of fluid, thus protecting the components within the housing 102. For example, epoxy may be positioned at joints between various components of the sight 100 to reduce the likelihood of fluids entering into the housing 102 and degrading components.

The housing 102 may include a single monolithic component or multiple components coupled together using any known means (e.g., connectors, fasteners, adhesive, or the like). The housing 102 may be designed to be coupled to a receiver of a firearm such as a handgun, a long gun (e.g., a rifle), or the like; to be coupled to a non-firearm weapon (e.g., a crossbow), or to be used separate from any weapons. In that regard, the housing 102 may include a mount 116 designed to be removably or permanently coupled to a receiver of a firearm. The mount 116 may include a fastener 118 for fastening the mount 116, and thus the sight 100, onto the receiver of the firearm. That is, the mount 116 may be positioned on a receiver, and the fastener 118 may be engaged to couple the sight 100 to the receiver.

The housing 102 may have a front 112 and a rear 114. When coupled to a receiver, the rear 114 may be positioned closer to the trigger of the weapon than the front 112, and the front 112 may be positioned closer to a projectile outlet of the weapon than the rear 114. In that regard, the front 112, and thus the target side window 104, may face and be positioned closer to a target than the rear 114, and the rear 114, and thus the viewing window 106, may be positioned closer to a user (e.g., an eye of a user) than the front 112. In that regard, the sight 100 may be aligned between a user and a target with the viewing window 106 closer to the user and the target side window 104 closer to the target. The user may look into the sight 100 via the viewing window 106, may look out of the sight 100 via the target side window 104, and the reticle may be positioned within the sight 100 such that the user can view the reticle when looking through the sight 100 from the viewing window 106 towards the target side window 104. That is, a viewing channel 408 may be present between the viewing window 106 and the target side window 104, and the holographic reticle may be viewed within the viewing channel 408.

The sight 100 (e.g., the housing 102) may include a first side 120 which may be defined by a first outer side wall 120, and a second side 122 which may be defined by a second outer side wall 122. The sight 100 (e.g., the housing 102) may include a top 124 which may be defined by a top outer side wall 124, and a bottom 126 which may be defined by a bottom outer side wall 126. The side walls may be formed integral, or monolithic, with the housing 102 or may be formed separately and coupled to the housing 102. The mount 116 may be positioned at or near the bottom 126 of the sight 100 such that the bottom 126 may be coupled to the receiver of the weapon. The top 124 may be an area of the sight 100 that is positioned farthest from the receiver in response to the sight 100 being coupled to the receiver. The windows 104, 106 may be positioned closer to the top 124 of the sight than the bottom 126.

The sight 100 may include at least one input device (e.g., a plurality of buttons 128) used to operate the electronics within the sight 100. In some embodiments, the sight 100 may include at least two buttons 128, at least three buttons 128, or the like. For example, a first button 130 may be used to toggle the power of the electronics of the sight 100 (e.g., to turn the sight 100 on or off) or to toggle additional features of the sight 100 (such as a night vision feature). A second button 132 may be used to increase a size of the reticle shown within the sight 100, and a third button 134 may be used to decrease a size of the reticle shown within the sight 100. These controls are exemplary only, and one skilled in the art will realize that the buttons 128 (or other input device(s)) may be used for any purpose.

As will be discussed in further detail below, the sight 100 may include one or more actuator for adjusting the position of the reticle relative to the windows 104, 106. For example, the sight 100 may include a first adjustment actuator 136 to adjust a vertical position of the reticle relative to the windows 104, 106 (i.e., closer to the top 124 or the bottom 126), and a second adjustment actuator 138 to adjust a horizontal position of the reticle relative to the windows 104, 106 (i.e., closer to the first side 120 or the second side 122). The adjustment actuators may include any type of actuator such as an electrical actuator (e.g., such as buttons, a controller, and a motor), a mechanical actuator (e.g., a knob, dial, or the like) as shown, or any combination thereof.

The sight 100 may be designed to include or be coupled to a power source (e.g., a battery, a supercapacitor, or a cable coupled to an external power source) that provides electrical power to electronic components of the sight 100 (such as the light source 300). In the embodiments shown in the drawings, the power source includes a battery. In that regard, the sight 100 may include a battery socket 310 having a removable battery cap 140 and designed to receive a removable battery. The battery cap 140 may be removed to provide access to the battery socket 310, a battery may be inserted into the battery socket 310, and the battery cap 140 may be coupled back on the sight 100 to enclose the battery within the battery socket 310. Coupling of the battery cap 140 to the housing 102 with the battery enclosed within the battery socket 310 may close an electrical power circuit, thus providing electrical power to the electronic component(s). For example, the battery cap 140 may include screw threading to match threading in the battery socket 310 such that the battery cap 140 may be placed against the socket 310 and rotated to fasten the battery cap 140 to the sight 100 and enclose the battery within the socket 310.

In some embodiments, the battery socket 310 (and thus the battery and battery cap 140) may be positioned vertically between the receiver (or the mount 116) and the viewing channel 408 (i.e., positioned parallel to a longitudinal axis A-A′) so as not to obstruct the view in the viewing channel 408. In some embodiments, the battery socket 310 and battery cap 140 may be positioned closer to the viewing window 106 than the target side window 104. However, the battery socket 310 and battery cap 140 may be positioned at any location within or coupled to the housing 102 without departing from the scope of the present disclosure.

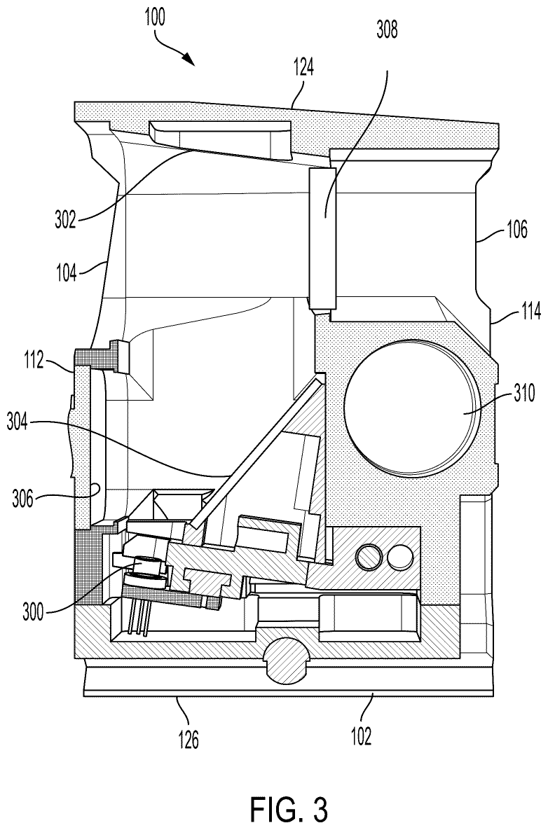

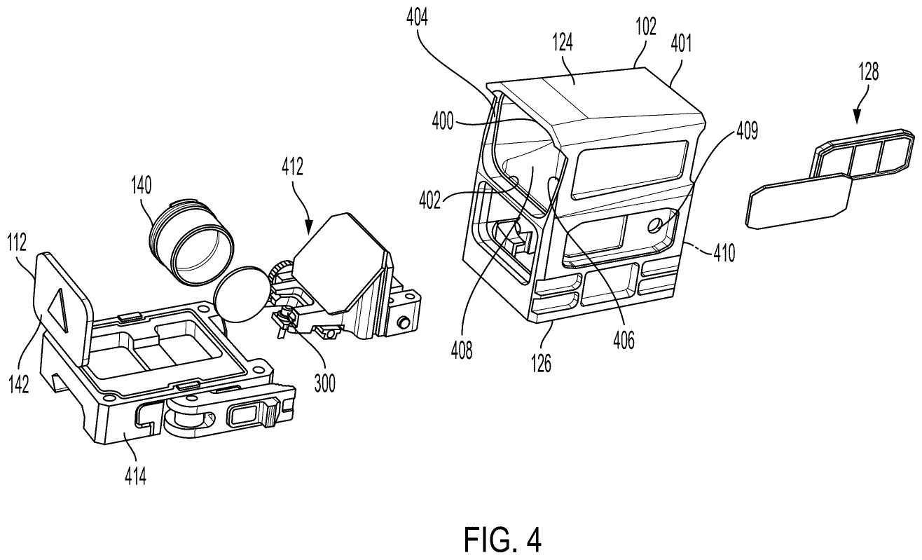

The light path within the sight 100 is designed to facilitate advantageous physical dimensions of the sight 100, as discussed above. With specific reference to FIG. 3, the sight 100 may include a plurality of optical components which together form the light path. In particular, the sight 100 may include a light source 300. The light source 300 may include any light source such as a laser diode or other light emitting diode (LED). The light source 300 may be positioned within the housing 102 and located towards the bottom 126 of the housing 102, and may be oriented in such a manner so as to emit a light beam towards the top 124 of the housing 102. A mirror 302 may be placed in the housing and located at or near the top 124 of the housing 102, and may redirect the light beam downwards (i.e., towards the bottom 126) from the top 124 of the housing 102. A second mirror 304 may be positioned within the housing 102 and coupled to a structure on which the light source 300 is coupled (a light source and adjustment mechanism 412, shown in detail in FIG. 4), and positioned to receive the light beam reflected from the first mirror 302. A grating plate, or diffraction grating plate 306, may be positioned within the housing 102 and oriented to receive the light beam reflected from the second mirror 304. The grating plate 306 may separate the light into component wavelengths, dispersing white light into its constituent colors. Diffracted light from the grating plate 306 (e.g., certain wavelengths of light) may be directed towards a holographic plate 308, which creates a holographic reticle within the viewing channel 408.

The holographic plate 308 may be oriented substantially parallel to the target side window 104 and the viewing window 106 and may position the reticle between the windows 104, 106 (i.e., within the viewing channel 408). In that regard, a user may peer into the housing 102 via the viewing window 106 and out of the housing 102 via the target side window 104. Because the holographic plate 308 is positioned between the windows 104, 106, the reticle may be positioned within the view of the user in the viewing channel 408. Stated differently, a user may view a target through the housing 102 via the windows 104, 106, and the reticle may be positioned within the view of the user, such that the corresponding weapon is aimed to fire towards the position of the reticle.

Referring again to FIGS. 1A through 8, multiple components may be positioned within and coupled to the housing 102. In particular, the housing 102 may include a shaped frame 401 defining one or more volume into which components are positioned. The components may be at least one of coupled together or coupled to the shaped frame 401 (or another portion) of the housing 102. The housing 102 may include a top internal wall 400, a bottom internal wall 402, and two internal vertical walls 404 that define a viewing channel 408 (i.e., the windows 104, 106 and the internal walls 400, 402, 404, 406 may define the viewing channel 408 within the housing 102). The internal walls 400, 402, 404, 406 may be formed integral, or monolithic, with the shaped frame 401, may be formed separate from the shaped frame 401 and coupled to the shaped frame 401, or any combination thereof.

A circuit board 410 (e.g., a printed circuit board (PCB)) may be positioned on and coupled to an internal wall of the housing 102 (e.g., an internal surface of the first outer side wall 120). In particular, the circuit board 410 may be coupled to an internal wall that is not part of the viewing channel 408 so as to avoid adding obstructions to the viewing channel 408. The buttons 128 may be positioned on and coupled to an outside of the housing 102 (e.g., an outer surface of the first outer side wall 120). In some embodiments, the buttons 128 may be aligned with the circuit board 410 such that only a wall (e.g., the first outer side wall 120) is between the buttons 128 and the circuit board 410. At least one of the buttons 128 may also be positioned adjacent to at least one other of the buttons 128. In some embodiments, the buttons 128 may be provided as a single component, or as multiple components coupled together.

One or more aperture through the housing 102 may exist (e.g., through the first outer side wall 120) such that the buttons 128 and the circuit board 410 may be at least one of mechanically or electrically coupled together. The outside of the housing 102 (e.g., the outer surface of the first outer side wall 120) may define a button seat 409 (such as an indentation in the wall) into which the buttons 128 may be positioned. In some embodiments, the buttons 128 may be coupled to the housing 102 via a connection between the buttons 128 and the circuit board 410 (e.g., a wire). In some embodiments, another component (such as a fastener or adhesive) may be used to couple the buttons 128 to the housing 102 within the button seat 409. Due to the design of the light path, the circuit board 410 may be positioned within, coupled to, and oriented parallel to one of the outer side walls 120, 122, and the buttons 128 may be positioned outside of, coupled to, and oriented parallel to the outside of the one of the outer walls 120, 122. The circuit board 410 may be coupled to the housing using any known means such as a fastener, adhesive, or the like.

The sight 100 may also include the light source and adjustment mechanism 412 that includes, or is coupled to, the light source 300, the adjustment actuators 136, 138, and the second mirror 304. As will be discussed in further detail below, the light source and adjustment mechanism 412 may be used to reposition the reticle within the viewing channel 408. In some embodiments, the light source 300 may be removably coupled to the light source and adjustment mechanism 412 such that it can be replaced with an alternative light source should the original stop functioning properly.

The sight 100 may also include a base 414 designed to be coupled to the frame 401 and to enclose various components of the sight 100 within the frame 401. The base 414 may include the mount 116 and the fastener 118 via which the sight 100 may be coupled to a receiver of a firearm, or the mount 116 and the fastener 118 may be separate components. The mount 116 and fastener 118 may include any known attachment mechanism via which the base 414, and thus the sight 100, may be coupled to a receiver of a firearm. The base 414 may also include a front plate 142 which further encloses components within the frame 401, such that it functions as an external portion of the housing 102. In that regard, the light source and adjustment mechanism 412, the mirrors 302, 304, the circuit board 410, and any other components of the sight 100 may be positioned within or coupled to the frame 401, and the base 414 may be coupled to the frame 401 to enclose the components within the housing 102.

The sight 100 may be designed to facilitate adjustment of the position of the reticle between the windows 104, 106 (i.e., within the viewing channel 408). In particular, the first adjustment actuator 136 may adjust a vertical position of the reticle within the viewing channel 408 (i.e., closer to the top 124 or the bottom 126), and the second adjustment actuator 138 may adjust a horizontal position of the reticle within the viewing channel 408 (i.e., closer to the first side 120 or the second side 122). The light source and adjustment mechanism 412 may include a wedge 702 coupled to the first adjustment actuator 136 and positioned adjacent to a structure of the light source and adjustment mechanism 412. Adjustment of the first adjustment actuator 136 (e.g., by rotating a wheel) may urge the wedge 702 towards or away from the structure of the light source and adjustment mechanism 412. As the wedge 702 is moved towards or away from the structure, the light source 300 is pivoted forward or backwards relative to the housing 102 (i.e., towards the top 124 or the bottom 126). This pivoting adjusts the vertical position of the reticle within the viewing channel 408.

The second adjustment actuator 138 may be coupled to the light source 300 via a shaft (not shown). Adjustment of the second adjustment actuator 138 causes the light source to shift left and right (i.e., towards the first side 120 or the second side 122), thus adjusting the horizontal position of the reticle within the viewing channel 408.

As referenced above, the light path of the optical components within the sight 100 facilitates desirable characteristics of the sight 100, such as dimensions and structural ratios of the sight 100 and the various features thereof. The sight 100 may be oriented along the longitudinal axis A-A′ which may be positioned parallel to a longitudinal axis of a receiver of a weapon to which the sight 100 is attached.

The target side window 104 and the viewing window 106 may be aligned along the axis A-A′, and may be sized to achieve certain advantages. In particular, the target side window 104 may have a first dimension 200 and a second dimension 202, and the viewing window 106 may have a first dimension 204 that aligns with the first dimension 200 of the target side window 104 and a second dimension 206 that aligns with the second dimension 202 of the target side window 104. In some embodiments, at least one of the first dimension 200 or the second dimension 202 of the target side window 104 may be greater than the respective first dimension 204 or the second dimension 206 of the viewing window 106. In some embodiments, both the first dimension 200 and the second dimension of the target side window 104 may be greater than the respective first dimension 204 and the second dimension 206 of the viewing window 106. This greater dimension reduces the likelihood of internal walls 400, 402, 404, 406 obstructing a view of a user through the viewing channel 408.

For example, the first dimension 200 of the target side window 104 may be between 0.5 inches and 3 inches (1.27 centimeters (cm) and 7.62 cm), between 1 inch and 2 inches (2.54 cm and 5.08 cm), or about 1.52 inches (3.861 cm). Where used in this context, “about” refers to the referenced value plus or minus 10 percent of the referenced value. For example, the second dimension 202 of the target side window 104 may be between 0.25 inches and 3 inches (0.635 cm and 7.62 cm), between 0.5 inches and 2 inches (1.27 cm and 5.08 cm), or about 1.13 inches (2.87 cm).

For example, the first dimension 204 of the viewing window 106 may be between 0.25 inches and 3 inches (0.635 cm and 7.62 cm), between 0.5 inches and 2 inches (1.27 cm and 5.08 cm), or about 1.2 inches (3.05 cm). For example, the second dimension 206 of the viewing window 106 may be between 0.1 inches and 2 inches (0.254 cm and 5.08 cm), between 0.25 inches and 2 inches (1.27 cm and 5.08 cm), or about 0.81 inches (2.06 cm).

As a result of the greater dimension of the target side window 104 relative to the viewing window 106, the internal walls 400, 402, 404, 406 may fail to obstruct any of the viewing channel 408, or may only minimally obstruct any portion of the viewing channel 408. In that regard, at least a portion of at least one of the internal walls 400, 402, 404, 406 may be tapered from the target side window 104 (or the aperture 108 therefore) to the viewing window 106 (or the aperture 110 therefore).

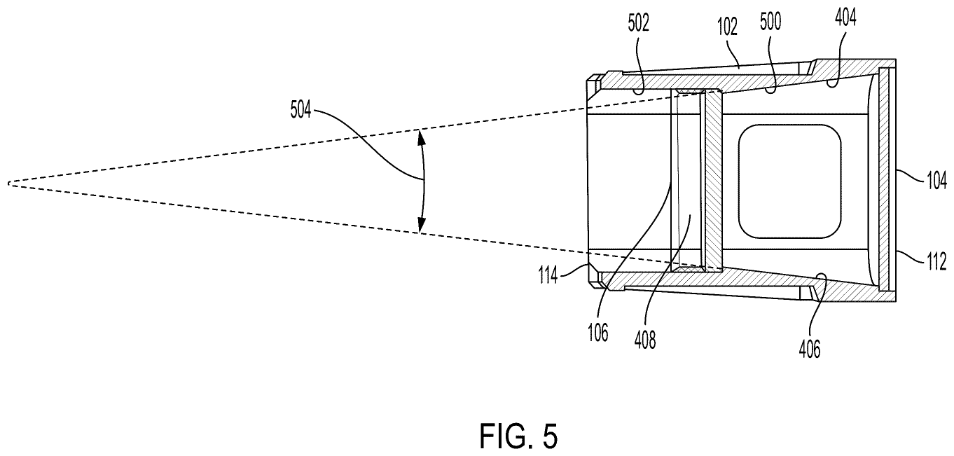

With specific reference to FIG. 5, a top-down cross-sectional view of the sight 100 illustrates an exemplary horizontal taper. In particular, at least one of the first vertical wall 404 or the second vertical wall 406 (which partially define the viewing channel 408) may be tapered from the target side window 104 to the viewing window 106. For example, the internal vertical walls 404, 406 may each have a first portion 500 extending from the front 112 of the sight 100 towards the back 114 of the sight 100, and a second portion 502 extending from the first portion 500 to the back 114 of the sight. In some embodiments and as shown, the first portion 500 of the vertical walls 404, 406 may be tapered, and the second portion 502 of the vertical walls 404, 406 may be oriented parallel to each other. In some embodiments, the entirety of each vertical wall 404, 406 may be tapered, the entirety of each vertical wall 404, 406 may be straight, or any combination thereof. In the embodiment shown in FIG. 5, both internal vertical walls 404, 406 each include first portions 500 that are tapered and second portions 502 that are parallel relative to each other. In some embodiments, the taper of the internal vertical walls 404, 406 creates a horizontal viewing angle 504, which may be between 1 degree and 45 degrees, between 5 degrees and 30 degrees, between 10 degrees and 20 degrees, or about 14 degrees (again, “about” in this context refers to the referenced value plus or minus 10 percent of the referenced value).

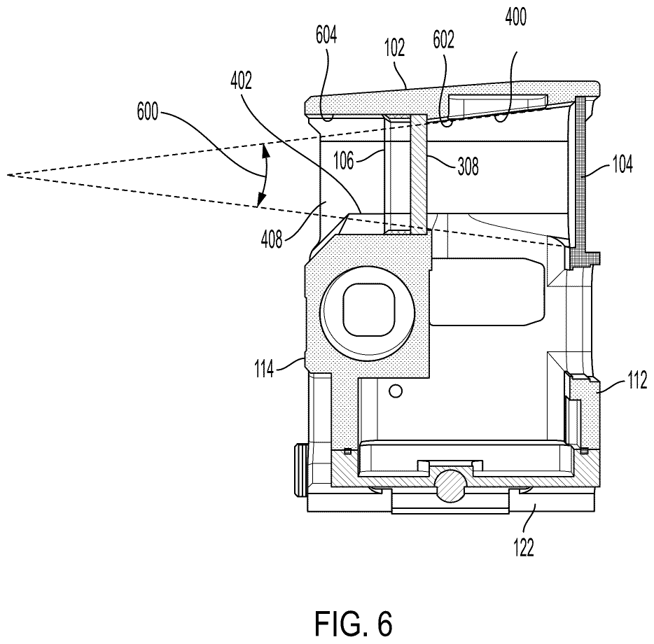

With specific reference to FIG. 6, a side cross-sectional view of the sight 100 illustrates an exemplary vertical taper. In particular, at least one of the top internal wall 400 or the bottom internal wall 402 (which partially define the viewing channel 408) may be tapered from the target side window 104 to the viewing window 106. For example, the top and bottom internal walls 400, 402 may each have a first portion 602 extending from the front 112 of the sight 100 towards the back 114 of the sight 100, and a second portion 604 extending from the first portion 602 to the back 114 of the sight. In some embodiments and as shown, the first portions 602 of the top and bottom internal walls 400, 402 may be tapered, and the second portions 604 may be oriented parallel to each other. In some embodiments, the entirety of each of the top and bottom internal walls 400, 402 may be tapered, the entirety of each of the top and bottom internal walls 400, 402 may be straight, or any combination thereof. In the embodiment shown in FIG. 6, each of the top and bottom internal walls 400, 402 include first portions 602 that are tapered and second portions 604 that are parallel relative to each other (i.e., non-tapered). In some embodiments, the taper of the top and bottom internal walls 400, 402 creates a vertical viewing angle 600, which may be between 1 degree and 45 degrees, between 5 degrees and 30 degrees, between 10 degrees and 20 degrees, or about 14 degrees.

Referring to FIGS. 5 and 6 specifically, the tapered design of the internal walls may be implemented in sights other than holographic sights (e.g., iron sights that include a metal form on the receiver or in a housing of the sight, laser sights that aim a laser towards a target and may include a window for viewing the laser, reflex sights that project a dot onto a reflexive glass, or the like). In that regard, the non-holographic sights may include a reticle-forming element (e.g., a metal structure, a light source that projects light onto reflexive glass, a laser light projected towards a target, or the like).

The non-holographic sights may or may not include windows but do include a viewing channel with a target side aperture or opening, a viewing side aperture or opening, and internal walls extending from the target side aperture to the viewing side aperture. The apertures and internal walls may define the viewing channel. A reticle may be viewable through the viewing channel by looking through the viewing aperture and out of the target side aperture. At least a portion of at least one of the internal walls may be tapered inward from the target side aperture to the viewing aperture. The taper may extend the entire distance from the target side aperture to the viewing aperture or may only extend for a portion of the distance from the target side aperture to the viewing aperture (i.e., the vertical walls may include first portions 500 and second portions 502, and the horizontal walls may include first portions 602 and second portions 604). Similarly, any quantity of internal walls may be tapered, and the tapered walls may be opposite each other, adjacent to each other, or both. In that regard, the features of the viewing channel 408 and internal walls 400, 402, 404, 406 shown in FIGS. 5 and 6 may be applied to sights other than holographic sights (and the non-holographic sights may thus lack a holographic plate and other features shown in FIGS. 5 and 6).

Returning reference to FIGS. 1A through 8, the layout of the sight 100 also allows the sight 100 to be coupled to a receiver in a way that facilitates natural aiming. The sight 100 may rest on top of a receiver when the mount 116 is coupled to the receiver, such that a top of the receiver is aligned with a line 216 that extends through the mount when the fastener 118 is fastened. The sight 100 (and thus the housing 102) may have a height 208 that extends from the line 216 in a direction perpendicular to the axis A-A′. That is, the top 124 of the housing is positioned the height 208 away from the top of the receiver when the sight 100 is coupled to the receiver. The sight 100 may also have a length 210 that extends from the front 112 of the sight 100 (or the housing 102) to the rear 114 of the sight 100 (or the housing 102). The length 210 may be in a direction parallel to the axis A-A′.

The height 208 may be between 1 inch and 6 inches (2.54 cm and 15.24 cm), between 1.5 inches and 5 inches (3.81 cm and 12.7 cm), between 2 inches and 4 inches (5.08 cm and 10.16 cm), or about 2.93 inches (7.442 cm). The length 210 may be between 0.5 inches and 5 inches (1.27 cm and 12.7 cm), between 1 inch and 4 inches (2.54 cm and 10.16 cm), between 1.5 inches and 3 inches (3.81 cm and 7.62 cm), or about 2.13 inches (5.410 cm).

The sight 100 (or housing 102) may have a first width 212 at the front 112 and a second width 214 at the rear 114. For example, the first width 212 may be between 0.5 inches and 4 inches (1.27 cm and 10.16 cm), between 0.75 inches and 3 inches (1.91 cm and 7.62 cm), between 1 inch and 2 inches (2.54 cm and 5.08 cm), or about 1.65 inches (4.191 cm). The second width 214 may be between 0.5 inches and 5 inches (1.27 cm and 12.7 cm), between 1 inch and 4 inches (2.54 cm and 10.16 cm), between 1.5 inches and 3 inches (3.81 cm and 7.62 cm), or about 2.12 inches (5.385 cm).

As discussed above, the ratio of the height 208 of the sight 100 (or the housing 102) to the length 210 of the sight 100 (or the housing 102) may provide advantages over conventional holographic sights. In particular, the height 208 may be greater than the length 210, the height 208 may be greater than 1.3 times the length 210, the height may be greater than 1.5 times the length 210, or the like. These dimensions and ratios are designed to allow the entire light path to be housed in the housing 102 while also providing advantages such as aligning the viewing channel 408 with a natural eye position while shooting, allowing the sight 100 to be mounted on a handgun, facilitating additional accessories on a firearm receiver, and the like.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

1. A holographic sight, comprising:
a light source configured to generate a light beam;
a holographic plate configured to convert light to a holographic reticle;
a target side window and a viewing window having a smaller horizontal dimension than the target side window and a smaller vertical dimension than the target side window; and
a housing extending from a target side to a viewing side, and defining apertures on the target side for receiving the target side window and the viewing side for receiving the viewing window, and configured to house the light source and the holographic plate.

2. The holographic sight of claim 1, wherein the housing is configured to be mounted on a receiver of a firearm, the receiver having a longitudinal axis.

3. The holographic sight of claim 2, wherein:
the housing has a height extending perpendicular to the longitudinal axis of the receiver and a length extending parallel to the longitudinal axis of the receiver; and
the height of the housing is greater than the length of the housing.

4. The holographic sight of claim 3, wherein the height of the housing is greater than 1.3 times the length of the housing.

5. The holographic sight of claim 2, wherein the housing includes internal walls defining a viewing channel between the aperture for the target side window and the aperture for the viewing window, wherein a portion of at least one of the internal walls is tapered from the aperture for the target side window to the aperture for the viewing window.

6. The holographic sight of claim 5, wherein:
the internal walls include horizontal walls and vertical walls;
the horizontal walls include a bottom wall and a top wall configured to be positioned farther from the receiver than the bottom wall; and
at least one of the bottom wall or the top wall is tapered towards the other of the bottom wall or the top wall between the aperture for the target side window and the aperture for the viewing window.

7. The holographic sight of claim 6, wherein:
the vertical walls include a first vertical wall and a second vertical wall; and
at least one of the first vertical wall or the second vertical wall is tapered towards the other of the first vertical wall or the second vertical wall from the aperture for the target side window to the aperture for the viewing window.

8. The holographic sight of claim 5, wherein the holographic plate is positioned within the viewing channel and oriented in a direction parallel to the aperture for the target side window and the aperture for the viewing window.

9. The holographic sight of claim 2, wherein the housing includes a first outer side wall and a second outer side wall oriented substantially parallel to the first outer side wall, and wherein the first outer side wall and the second outer side wall are oriented substantially perpendicular to the longitudinal axis of the receiver.

10. The holographic sight of claim 9, further comprising at least two buttons each positioned on one of the first outer side wall or the second outer side wall and positioned adjacent to the other button of the at least two buttons.

11. The holographic sight of claim 9, further comprising a circuit board configured to be housed within the housing and oriented parallel to at least one of the first outer side wall or the second outer side wall.

12. The holographic sight of claim 2, wherein the housing further defines a battery socket configured to receive a battery, and wherein the battery socket is positioned between the receiver and the apertures for the viewing window and the target side window, and positioned closer to the viewing window than the target side window.

13. A holographic sight for use with a firearm, the holographic sight comprising:
a light source configured to generate a light beam;
a holographic plate configured to convert light to a holographic reticle;
a target side window and a viewing window; and
a housing extending from a target side to a viewing side and defining apertures for receiving the target side window on the target side and the viewing window on the viewing side, configured to house the light source and the holographic plate, and configured to be coupled to a receiver of the firearm, the housing having a length extending parallel to the longitudinal axis of the receiver and a height extending perpendicular to a longitudinal axis of the receiver and being greater than the length.

14. The holographic sight of claim 13, wherein the target side window has a different dimension in height and width than the viewing side window.

15. The holographic sight of claim 13, wherein the housing includes internal walls defining a viewing channel between the aperture for the target side window and the aperture for the viewing window, wherein a portion of at least one of the internal walls is tapered from the aperture for the target side window to the aperture for the viewing window.

16. The holographic sight of claim 15, wherein the holographic plate is positioned within the viewing channel and oriented in a direction parallel to the aperture for the target side window and the aperture for the viewing window.

17. The holographic sight of claim 13, wherein the height of the housing is greater than 1.3 times the length of the housing.

18. A sight for use with a firearm, comprising:
a target side aperture and a viewing aperture having a smaller horizontal dimension and a smaller vertical dimension than the target side aperture;
internal walls defining a viewing channel between the target side aperture and the viewing aperture;
a reticle-forming element observable by peering through the viewing channel via the viewing aperture; and
a housing at least partially defining or coupled to the target side aperture, the viewing aperture, the internal walls, and the reticle-forming element, and configured to be coupled to a receiver of the firearm,
the target side aperture being on a target end of the housing;
the viewing side aperture being on a viewing end of the housing opposite the target end of the housing;
wherein at least a portion of at least one of the internal walls of the housing in a horizontal dimension and in a vertical dimension is tapered from the target side aperture to the viewing aperture.

19. The sight of claim 18, wherein:
the internal walls include horizontal walls and vertical walls;
the horizontal walls include a bottom wall and a top wall configured to be positioned farther from the receiver than the bottom wall; and
at least one of the bottom wall and the top wall is tapered towards the other of the bottom wall or the top wall between the target side aperture and the viewing aperture such that the target side aperture has at least one dimension that is greater than a corresponding dimension of the viewing aperture.

20. The sight of claim 19, wherein:
the vertical walls include a first vertical wall and a second vertical wall; and
at least one of the first vertical wall or the second vertical wall is tapered towards the other of the first vertical wall or the second vertical wall from the target side aperture to the viewing aperture such that the target side aperture has at least two dimensions that are greater than corresponding dimensions of the viewing aperture.
